(19) United States
(12) Patent Application Publication
(10) Pub. No.: US 2026/0136113 A1
(43) Pub. Date: May 14, 2026

(54) INFORMATION PROCESSING DEVICE AND INFORMATION PROCESSING METHOD

(71) Applicant: CANON KABUSHIKI KAISHA, Tokyo (JP)

(72) Inventor: KOKI HONDA, Kanagawa (JP)

(21) Appl. No.: 19/374,899

(22) Filed: Oct. 30, 2025

(30) Foreign Application Priority Data
Nov. 8, 2024 (JP) 2024-196104

(51) Int. Cl. H04N 25/62; H04N 25/53; H04N 25/773

(52) U.S. Cl. CPC H04N 25/62; H04N 25/53; H04N 25/773

(57) ABSTRACT

A device includes an acquisition unit acquiring a correction amount of a signal generated by photoelectrically converting incident light in each pixel, and a correction unit correcting the signal based on the correction amount. One exposure period in each pixel is divided into first periods. A first output value of each pixel is generated in each first period. The signal including a second output value that is an accumulated value of the first output values over the first periods is input to the acquisition unit for each pixel. The acquisition unit calculates a first probability that one of possible values of the first output value of a first pixel is generated, a second probability that one of possible values of the first output value of a second pixel is generated, and the correction amount based on the first and second probabilities.

### BACKGROUND

### Field of the Technology

The aspect of the embodiments relates to an information processing device and an information processing method.

### Description of the Related Art

Some imaging devices such as digital cameras have a plurality of imaging elements that photoelectrically convert incident light into electrical signals. In an imaging device including a plurality of imaging elements, some of the plurality of imaging elements may output abnormally high-level signals.

Japanese Patent Laid-Open No. 2023-118661 proposes a method of correcting a cluster-like defect across a plurality of pixels including a pixel in which an imaging element that outputs such an abnormally high-level signal is arranged. Japanese Patent Laid-Open No. 2021-044636 proposes a photoelectric conversion device capable of performing various arithmetic processing on a counting result of a detection signal in a signal processing circuit that generates an output signal.

There is room for further improvement in accuracy in a method of correcting an output signal of a photoelectric conversion device as disclosed in Japanese Patent Laid-Open No. 2023-118661 and Japanese Patent Laid-Open No. 2021-044636.

### SUMMARY

According to one aspect of the embodiments, there is provided a device including an acquisition unit configured to acquire a correction amount of a signal generated by converting incident light in each of a plurality of pixels, and a correction unit configured to correct the signal based on the correction amount. One exposure period in each of the plurality of pixels is divided into a plurality of first periods. A first output value of each of the plurality of pixels is generated in each of the plurality of first periods. The signal including a second output value that is an accumulated value of the first output values over the plurality of first periods is input to the acquisition unit for each pixel. The acquisition unit calculates, based on the second output value of a first pixel among the plurality of pixels, a first probability that one of possible values of the first output value is generated in each of the plurality of first periods. The acquisition unit calculates, based on the second output value of a second pixel among the plurality of pixels, a second probability that one of possible values of the first output value is generated in each of the plurality of first periods. The acquisition unit calculates the correction amount based on the first probability and the second probability.

According to one aspect of the embodiments, there is provided a device including an acquisition unit configured to acquire a correction amount of a signal generated by photoelectrically converting incident light in each of a plurality of pixels, and a correction unit configured to correct the signal based on the correction amount. One exposure period in each of the plurality of pixels is divided into a plurality of first periods. A first output value of each of the plurality of pixels is generated in each of the plurality of first periods. The signal including a second output value that is an accumulated value of the first output values over the plurality of first periods is input to the acquisition unit for each pixel. The acquisition unit acquires, based on the second output value of a first pixel among the plurality of pixels and the second output value of a second pixel among the plurality of pixels, the correction amount by referring to a table. The table includes a correction amount calculated in advance based on a first probability that one of possible values of the first output value is generated in the first pixel in each of the plurality of first periods and a second probability that one of possible values of the first output value is generated in the second pixel in each of the plurality of first periods.

According to one aspect of the embodiments, there is provided a method including acquiring a correction amount of a signal generated by photoelectrically converting incident light in each of a plurality of pixels, and correcting the signal based on the correction amount. One exposure period in each of the plurality of pixels is divided into a plurality of first periods. A first output value of each of the plurality of pixels is generated in each of the plurality of first periods. The signal including a second output value that is an accumulated value of the first output values over the plurality of first periods is input for each pixel. In the acquiring of the correction amount, a first probability that one of possible values of the first output value is generated in each of the plurality of first periods is calculated based on the second output value of a first pixel among the plurality of pixels, a second probability that one of possible values of the first output value is generated in each of the plurality of first periods is calculated based on the second output value of a second pixel among the plurality of pixels, and the correction amount is calculated based on the first probability and the second probability.

According to one aspect of the embodiments, there is provided a method including acquiring a correction amount of a signal generated by photoelectrically converting incident light in each of a plurality of pixels, and correcting the signal based on the correction amount. One exposure period in each of the plurality of pixels is divided into a plurality of first periods. A first output value of each of the plurality of pixels is generated in each of the plurality of first periods. The signal including a second output value that is an accumulated value of the first output values over the plurality of first periods is input for each pixel. In the acquiring of the correction amount, the correction amount is acquired by referring to a table based on the second output value of a first pixel among the plurality of pixels and the second output value of a second pixel among the plurality of pixels. The table includes a correction amount calculated in advance based on a first probability that one of possible values of the first output value is generated in the first pixel in each of the plurality of first periods and a second probability that one of possible values of the first output value is generated in the second pixel in each of the plurality of first periods.

Features of the disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of an information processing device according to a first embodiment.

FIG. 2 is a schematic diagram illustrating an overall configuration of a photoelectric conversion device according to the first embodiment.

FIG. 3 is a schematic block diagram illustrating a configuration example of a sensor substrate according to the first embodiment.

FIG. 4 is a schematic block diagram illustrating a configuration example of a circuit substrate according to the first embodiment.

FIG. 5 is a schematic block diagram illustrating a configuration example of one pixel of a photoelectric conversion unit and a pixel signal processing unit according to the first embodiment.

FIG. 6A, FIG. 6B, and FIG. 6C are diagrams illustrating an operation of an avalanche photodiode according to the first embodiment.

FIG. 7 is a functional block diagram related to correction processing of the information processing device according to the first embodiment.

FIG. 8 is a flowchart illustrating correction processing executed by the information processing device according to the first embodiment.

FIG. 9 is a diagram illustrating a concept of light emission crosstalk correction processing according to the first embodiment.

FIG. 10 is a diagram illustrating a concept of light emission crosstalk correction processing according to the first embodiment.

FIG. 11A and FIG. 11B are diagrams illustrating contribution ratios of light emission crosstalk correction processing according to the first embodiment.

FIG. 12 is a diagram illustrating a concept of light emission crosstalk correction processing according to a second embodiment.

FIG. 13 is a diagram illustrating an example of a lookup table according to a third embodiment.

FIG. 14 is a block diagram of equipment according to a fourth embodiment.

FIG. 15A and FIG. 15B are block diagrams of equipment according to a fifth embodiment.

### DESCRIPTION OF THE EMBODIMENTS

Hereinafter, embodiments of the disclosure will be described with reference to the drawings. The same or corresponding elements are denoted by the same reference numerals throughout the several drawings, and the description thereof may be omitted or simplified.

### First Embodiment

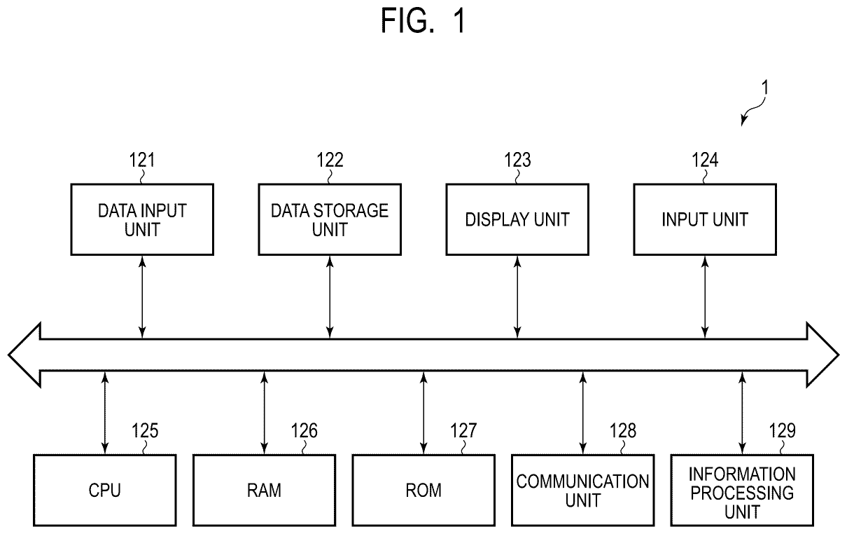

FIG. 1 is a block diagram illustrating a hardware configuration of an information processing device 1 according to the embodiment. The information processing device 1 performs information processing such as correction on pixel data acquired by a photoelectric conversion device. FIG. 1 illustrates an example in which information processing in the information processing device 1 is performed by a general computer, but the function of the information processing in the information processing device 1 may be realized by another device. For example, the information processing device 1 may be an image processing device specialized for an image processing function, or may be an image processing unit incorporated in a photoelectric conversion device.

The information processing device 1 includes a data input unit 121, a data storage unit 122, a display unit 123, and an input unit 124. In addition, the information processing device 1 includes a central processing unit (CPU) 125, a random access memory (RAM) 126, and a read only memory (ROM) 127. In addition, the information processing device 1 includes a communication unit 128 and an information processing unit 129. These units are connected to each other via a bus. FIG. 1 illustrates an example of the configuration of the information processing device 1, and a part of the unit illustrated in FIG. 1 may be arranged in a device outside the information processing device 1, or a device other than the units illustrated in FIG. 1 may be further arranged in the information processing device 1.

The data input unit 121 includes a photoelectric conversion device such as an image sensor. The photoelectric conversion device includes a plurality of pixel circuits arranged to form a plurality of rows and a plurality of columns. Each of the plurality of pixel circuits photoelectrically converts incident light to generate an electrical signal. The electrical signal generated by each of the plurality of pixel circuits is converted into a digital signal (pixel value). In this manner, the data input unit 121 has a function of generating pixel values of pixels arranged to form a plurality of rows and a plurality of columns as image data and inputting the image data to the information processing device 1. When the photoelectric conversion device is arranged outside the information processing device, the data input unit 121 may be an interface that acquires image data from the photoelectric conversion device.

The data storage unit 122 is a storage medium that stores data used for information processing on image data, parameters, or the like. The storage medium may be, for example, a computer-readable nonvolatile storage medium such as a hard disk, a solid state drive (SSD), or a flexible disk. The storage medium may be an optical disc such as compact disc (CD)-ROM, CD-recordable (CD-R), digital versatile disc (DVD), or Blu-ray (registered trademark). The storage medium may be a semiconductor memory such as a memory card, a compact flash (CF) card, a smart medium, an SD card, a memory stick, an XD picture card, or a universal serial bus (USB) memory. The data storage unit 122 may store data other than the program and the image data. Also, a part of the storage capacity of the RAM 126 may be used as the data storage unit 122. Alternatively, an external storage device communicatively connected to the information processing device 1 by the communication unit 128 may be used as the data storage unit 122.

The display unit 123 is a device that displays an image before image processing, displays an image after image processing, or displays an operation image such as a graphical user interface. The display unit 123 may be a cathode-ray tube (CRT) display, a liquid crystal display, an organic electro-luminescence (EL) display, or the like. Alternatively, the display unit 123 may be an external display provided outside the information processing device 1 and communicatively connected by a cable or the like.

The input unit 124 is a device for the user to input instructions or data. The input unit 124 includes a keyboard, a pointing device, and the like. Examples of pointing devices include a mouse, a trackball, a track pad, a tablet, and the like. Alternatively, when the information processing device 1 of the embodiment is applied to a device such as a digital camera or a printer, the input unit 124 may be a button, a dial, or the like. The input unit 124 may be a software keyboard displayed on a screen by software. In this case, the input unit 124 may be configured such that the user inputs characters to a software keyboard by operating buttons, dials, or pointing devices.

Note that the same device such as a touch screen device may also serve as the display unit 123 and the input unit 124. In this case, information input to the information processing device 1 by the user operating the operation screen displayed on the touch screen device is treated as input information from the input unit 124.

The input unit 124 may be configured to receive an instruction from the user through gesture recognition processing. In this case, the input unit 124 includes an input device for inputting an image captured by visible light or infrared light, and a recognition device that recognizes a gesture of the user from the image and converts the gesture into a command. The data input unit 121 may also serve as the input device. The recognition device may be added as a dedicated gesture recognition circuit, or may be realized by the CPU 125 executing a gesture recognition program.

The input unit 124 may be configured to receive an instruction from the user by voice recognition processing. In this case, the input unit 124 includes a microphone device and a recognition device that recognizes the user's utterance from audio data acquired by the microphone device and converts the utterance into a command. The recognition device may be added as a dedicated voice recognition circuit, or may be realized by the CPU 125 executing a voice recognition program.

Note that the gesture recognition processing and the voice recognition processing described above may be performed by a device external to the information processing device 1. In this case, the information processing device 1 communicates with an external device or a server on a network via the communication unit 128, and transmits image data or audio data to the external device or the server. The external device or the server is configured to receive image data or audio data in accordance with a predetermined communication procedure, perform recognition processing, and transmit data indicating a recognition result to the information processing device 1.

The CPU 125 is a processor that controls each unit of the information processing device 1 and performs information processing. The RAM 126 and the ROM 127 provide programs, data, working areas, and the like necessary for control and information processing to the CPU 125. When the program is stored in the data storage unit 122 or the ROM 127, the program is once read into the RAM 126 and then executed by the CPU 125. The information processing device 1 may be configured to receive a program from the outside via the communication unit 128. In this case, the program is once stored in the data storage unit 122 and then read into the RAM 126, or directly read into the RAM 126 from the communication unit 128 and then executed by the CPU 125.

Although FIG. 1 illustrates only one block indicating the CPU 125, the number of CPUs 125 is not limited to one. That is, the information processing device 1 may include a plurality of CPUs 125.

The communication unit 128 is an interface for performing communication between devices. The communication unit 128 may be based on a wired communication system such as a wired network, RS-232C, USB, IEEE 1284, IEEE 1394, or a telephone line. Alternatively, the communication unit 128 may be based on a wireless communication system such as infrared (IrDA), IEEE802.11a, IEEE802.11b, IEEE802.11g, IEEE802.11n, IEEE802.11ac, IEEE802.11ax. Alternatively, the communication unit 128 may be based on another wireless communication system such as Bluetooth (registered trademark), an ultra wide band (UWB), a wireless telephone line, or a near field communication (NFC). Alternatively, the communication unit 128 may be based on an inter-chip communication system such as an inter-integrated circuit (I2C) or a serial peripheral interface (SPI).

The number of communication methods supported by the communication unit 128 is not limited to one, and a plurality of communication systems may be supported. For example, the communication unit 128 may be configured to support two or more of the various communication systems described above. Alternatively, the information processing device 1 may include a plurality of communication units 128 that support different communication systems. Also in this case, the plurality of communication units 128 will be collectively referred to as communication units 128 in the embodiment.

The information processing unit 129 is a signal processing circuit including a digital signal processor (DSP), a logic circuit, and the like. Alternatively, the information processing unit 129 may be a graphics processing unit (GPU). The information processing unit 129 performs arithmetic processing on image data input from the data input unit 121 or image data held in the RAM 126, the data storage unit 122, or the like. The processing result in the information processing unit 129 may be output to the RAM 126, the data storage unit 122, the display unit 123, or the like, or may be output to an external device of the information processing device 1 via the communication unit 128. When the load of the arithmetic processing is small such as a case where a high calculation speed is not required or a case where the amount of data to be calculated is small, the CPU 125 may also serve as the information processing unit 129.

Although not illustrated in FIG. 1, a register circuit may be added, as necessary. The register circuit holds operation parameters of the CPU 125 or the information processing unit 129. The value held in the register circuit may be set by the CPU 125 or the information processing unit 129, or may be set by an external device via the communication unit 128.

When the information processing device 1 is a camera device, the display unit 123 may have a function of displaying a preview image of an object and a function of displaying a photographed image. However, these images may be displayed on another device (for example, a smartphone) connected via the communication unit 128. In that case, the display unit 123 may be omitted. Similarly, another device connected via the communication unit 128 may receive an instruction from the user, and the information processing device 1 may receive a command corresponding to the instruction via the communication unit 128, so that the information processing device 1 may perform an operation according to the command. In this case, the CPU 125 or the information processing unit 129 may perform processing of specifying corresponding operation from the command.

Alternatively, when processing and control by software are unnecessary, the CPU 125, the ROM 127, and the like may be omitted. As an example of such a case, there is a case where a logic circuit that realizes necessary processing and control is arranged in the information processing unit 129.

Alternatively, the information processing device 1 may be a stacked sensor in which a substrate in which a photoelectric conversion element is arranged and a substrate in which a signal processing circuit is arranged are stacked. In this case, a logic circuit, a memory, the CPU 125, and the like may be arranged inside the stacked sensor. In such a configuration, the data input unit 121 may include a photoelectric conversion element and peripheral circuits thereof. In addition, the data storage unit 122, the CPU 125, the RAM 126, the ROM 127, the communication unit 128, and the information processing unit 129 may be arranged inside the stacked sensor. In this case, the display unit 123 and the input unit 124 may be omitted.

Next, a specific configuration example of a photoelectric conversion device including an avalanche photodiode, which can be applied to the data input unit 121 of the information processing device 1 in FIG. 1, will be described. The configuration example of the embodiment is an example, and the photoelectric conversion device applicable to the data input unit 121 is not limited thereto.

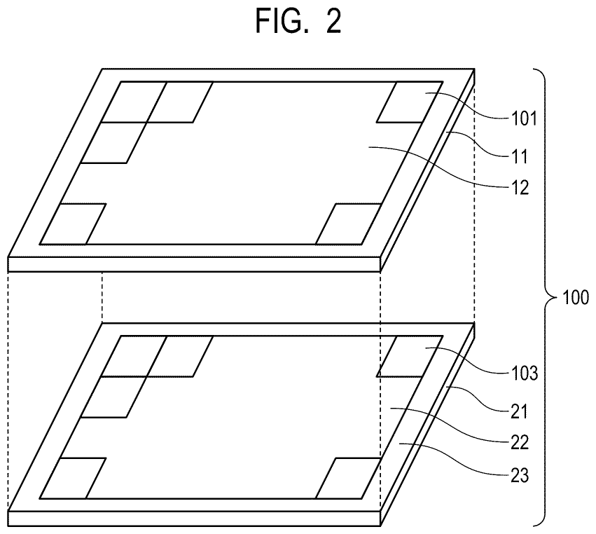

FIG. 2 is a schematic diagram illustrating an overall configuration of the photoelectric conversion device 100 according to the embodiment. The photoelectric conversion device 100 includes a sensor substrate 11 (first substrate) and a circuit substrate 21 (second substrate) stacked. The sensor substrate 11 and the circuit substrate 21 are electrically connected to each other. The sensor substrate 11 has a pixel region 12 in which a plurality of pixel circuits 101 are arranged to form a plurality of rows and a plurality of columns. The circuit substrate 21 includes a first circuit region 22 in which a plurality of pixel signal processing units 103 are arranged to form a plurality of rows and a plurality of columns, and a second circuit region 23 arranged outside the first circuit region 22. The second circuit region 23 may include a circuit for controlling the plurality of pixel signal processing units 103. The sensor substrate 11 has a light incident surface for receiving incident light and a connection surface opposed to the light incident surface. The sensor substrate 11 is connected to the circuit substrate 21 on the connection surface side. That is, the photoelectric conversion device 100 is a so-called backside illumination type.

In this specification, the term “plan view” refers to a view from a direction perpendicular to a surface opposite to the light incident surface. The cross section indicates a surface in a direction perpendicular to a surface opposite to the light incident surface of the sensor substrate 11. Although the light incident surface may be a rough surface when viewed microscopically, in this case, a plan view is defined with reference to the light incident surface when viewed macroscopically.

In the following description, the sensor substrate 11 and the circuit substrate 21 are diced chips, but the sensor substrate 11 and the circuit substrate 21 are not limited to chips. For example, the sensor substrate 11 and the circuit substrate 21 may be wafers. When the sensor substrate 11 and the circuit substrate 21 are diced chips, the photoelectric conversion device 100 may be manufactured by being diced after being stacked in a wafer state, or may be manufactured by being stacked after being diced.

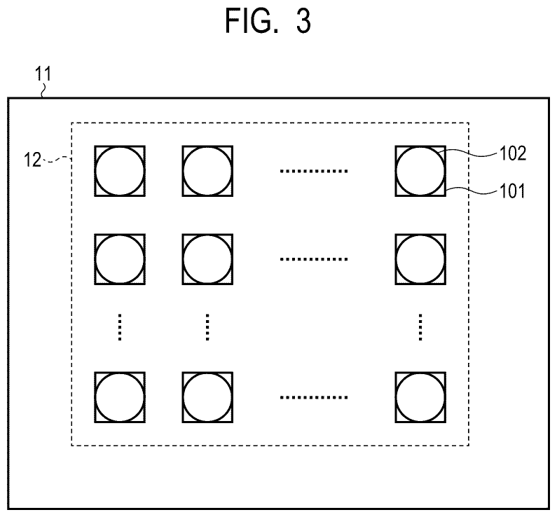

FIG. 3 is a schematic block diagram illustrating an arrangement example of the sensor substrate 11. In the pixel region 12, a plurality of pixel circuits 101 are arranged to form a plurality of rows and a plurality of columns. Each of the plurality of pixel circuits 101 includes a photoelectric conversion unit 102 including an avalanche photodiode (hereinafter referred to as APD) as a photoelectric conversion element in the substrate.

Of the charge pairs generated in the APD, the conductivity type of the charge used as the signal charge is referred to as a first conductivity type. The first conductivity type refers to a conductivity type in which a charge having the same polarity as the signal charge is a majority carrier. Further, a conductivity type opposite to the first conductivity type, that is, a conductivity type in which a majority carrier is a charge having a polarity different from that of a signal charge is referred to as a second conductivity type. In the APD described below, the anode of the APD is set to a fixed potential, and a signal is extracted from the cathode of the APD. Accordingly, the semiconductor region of the first conductivity type is an N-type semiconductor region, and the semiconductor region of the second conductivity type is a P-type semiconductor region. Note that the cathode of the APD may have a fixed potential and a signal may be extracted from the anode of the APD. In this case, the semiconductor region of the first conductivity type is the P-type semiconductor region, and the semiconductor region of the second conductivity type is then N-type semiconductor region. Although the case where one node of the APD is set to a fixed potential is described below, potentials of both nodes may be varied.

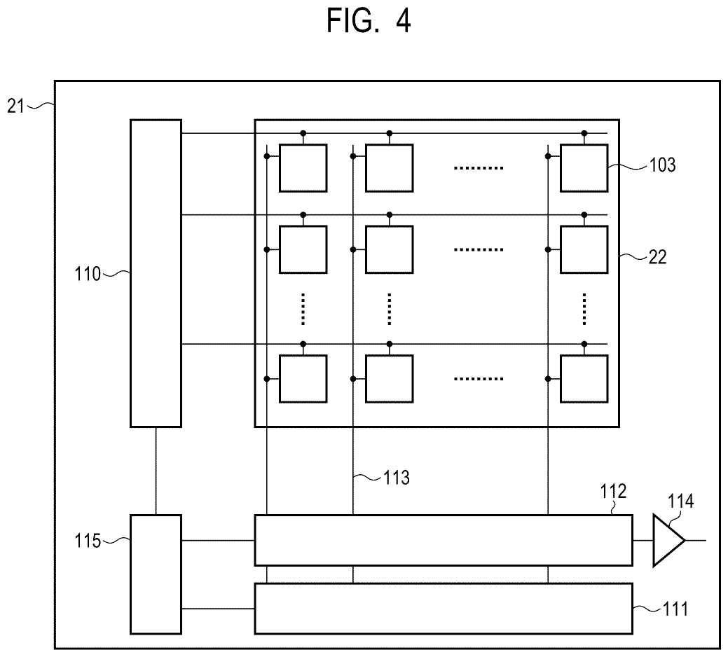

FIG. 4 is a schematic block diagram illustrating a configuration example of the circuit substrate 21. The circuit substrate 21 has the first circuit region 22 in which a plurality of pixel signal processing units 103 are arranged to form a plurality of rows and a plurality of columns.

The circuit substrate 21 includes a vertical scanning circuit 110, a horizontal scanning circuit 111, a reading circuit 112, a pixel output signal line 113, an output circuit 114, and a control signal generation unit 115. The plurality of photoelectric conversion units 102 illustrated in FIG. 3 and the plurality of pixel signal processing units 103 illustrated in FIG. 4 are electrically connected to each other via connection wirings provided for each pixel circuits 101.

The control signal generation unit 115 is a control circuit that generates control signals for driving the vertical scanning circuit 110, the horizontal scanning circuit 111, and the reading circuit 112, and supplies the control signals to these units. As a result, the control signal generation unit 115 controls the driving timings and the like of each unit.

The vertical scanning circuit 110 supplies control signals to each of the plurality of pixel signal processing units 103 based on the control signal supplied from the control signal generation unit 115. The vertical scanning circuit 110 supplies control signals for each row to the pixel signal processing unit 103 via a driving line provided for each row of the first circuit region 22. As will be described later, a plurality of driving lines may be provided for each row. A logic circuit such as a shift register or an address decoder can be used for the vertical scanning circuit 110. Thus, the vertical scanning circuit 110 selects a row to be output a signal from the pixel signal processing unit 103.

The signal output from the photoelectric conversion unit 102 of the pixel circuit 101 is processed by the pixel signal processing unit 103. The pixel signal processing unit 103 counts the number of pulses output from the APD included in the photoelectric conversion unit 102 to acquire and hold a digital signal having a plurality of bits.

The horizontal scanning circuit 111 supplies control signals to the reading circuit 112 based on a control signal supplied from the control signal generation unit 115. The pixel signal processing unit 103 is connected to the reading circuit 112 via a pixel output signal line 113 provided for each column of the first circuit region 22. The pixel output signal line 113 in one column is shared by a plurality of pixel signal processing units 103 in the corresponding column. The pixel output signal line 113 includes a plurality of wirings, and has at least a function of outputting a digital signal from the pixel signal processing unit 103 to the reading circuit 112, and a function of supplying a control signal for selecting a column for outputting a signal to the pixel signal processing unit 103. The reading circuit 112 outputs a signal to an external storage unit or signal processing unit of the photoelectric conversion device 100 via the output circuit 114 based on the control signal supplied from the control signal generation unit 115.

The arrangement of the photoelectric conversion units 102 in the pixel region 12 may be one-dimensional. Further, the function of the pixel signal processing unit 103 does not necessarily have to be provided one by one in all the pixel circuits 101. For example, one pixel signal processing unit 103 may be shared by a plurality of pixel circuits 101. In this case, the pixel signal processing unit 103 sequentially processes the signals output from the photoelectric conversion units 102, thereby providing the function of signal processing to each pixel circuit 101.

As illustrated in FIGS. 3 and 4, the first circuit region 22 having a plurality of pixel signal processing units 103 is arranged in a region overlapping the pixel region 12 in the plan view. In the plan view, the vertical scanning circuit 110, the horizontal scanning circuit 111, the reading circuit 112, the output circuit 114, and the control signal generation unit 115 are arranged so as to overlap a region between an edge of the sensor substrate 11 and an edge of the pixel region 12. In other words, the sensor substrate 11 includes the pixel region 12 and a non-pixel region arranged around the pixel region 12. In the circuit substrate 21, the second circuit region 23 having the vertical scanning circuit 110, the horizontal scanning circuit 111, the reading circuit 112, the output circuit 114, and the control signal generation unit 115 is arranged in a region overlapping with the non-pixel region in the plan view.

Note that the arrangement of the pixel output signal line 113, the arrangement of the reading circuit 112, and the arrangement of the output circuit 114 are not limited to those illustrated in FIG. 4. For example, the pixel output signal lines 113 may extend in the row direction, and may be shared by a plurality of pixel signal processing units 103 in corresponding rows. The reading circuit 112 may be provided so as to be connected to the pixel output signal line 113 of each row.

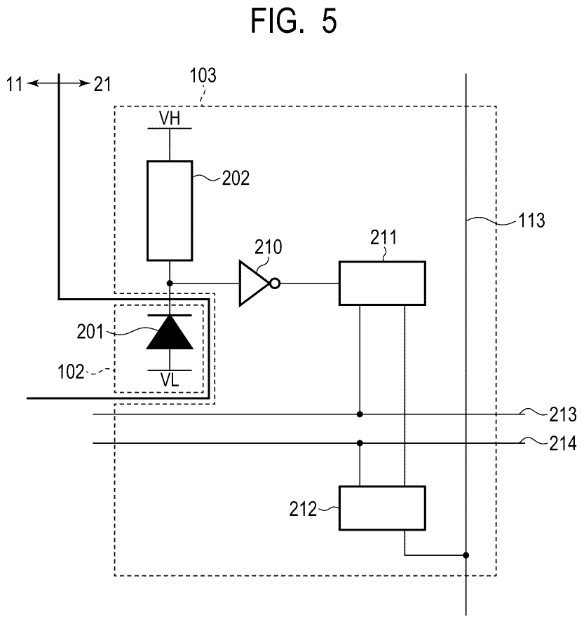

FIG. 5 is a schematic block diagram illustrating a configuration example of one pixel of the photoelectric conversion unit 102 and the pixel signal processing unit 103 according to the embodiment. FIG. 5 schematically illustrates a more specific configuration example including a connection relationship between the photoelectric conversion unit 102 arranged in the sensor substrate 11 and the pixel signal processing unit 103 arranged in the circuit substrate 21. In FIG. 5, driving lines between the vertical scanning circuit 110 and the pixel signal processing unit 103 in FIG. 4 are illustrated as driving lines 213 and 214.

The photoelectric conversion unit 102 includes an APD 201. The pixel signal processing unit 103 includes a quenching element 202, a waveform shaping unit 210, a counter circuit 211, and a selection circuit 212. The pixel signal processing unit 103 may include at least one of the waveform shaping unit 210, the counter circuit 211, and the selection circuit 212.

The APD 201 generates a charge pair corresponding to incident light by photoelectric conversion. A voltage VL (first voltage) is supplied to the anode of the APD 201. The cathode of the APD 201 is connected to a first terminal of the quenching element 202 and an input terminal of the waveform shaping unit 210. A voltage VH (second voltage) higher than the voltage VL supplied to the anode is supplied to the cathode of the APD 201. As a result, a reverse bias voltage that causes the APD 201 to perform the avalanche multiplication operation is supplied to the anode and the cathode of the APD 201. In the APD 201 to which the reverse bias voltage is supplied, when a charge is generated by the incident light, this charge causes avalanche multiplication, and an avalanche current is generated.

The operation modes in the case where a reverse bias voltage is supplied to the APD 201 include a Geiger mode and a linear mode. The Geiger mode is a mode in which a potential difference between the anode and the cathode is higher than a breakdown voltage, and the linear mode is a mode in which a potential difference between the anode and the cathode is near or lower than the breakdown voltage.

The APD operated in the Geiger mode is referred to as a single photon avalanche diode (SPAD). In this case, for example, the voltage VL (first voltage) is −30 V, and the voltage VH (second voltage) is 1 V. The APD 201 may operate in the linear mode or the Geiger mode. In the case of the SPAD, a potential difference becomes greater than that of the APD of the linear mode, and the effect of avalanche multiplication becomes significant, so that the SPAD may be used.

The quenching element 202 functions as a load circuit (quenching circuit) when a signal is multiplied by avalanche multiplication. The quenching element 202 suppresses the voltage supplied to the APD 201 and suppresses the avalanche multiplication (quenching operation). Further, the quenching element 202 returns the voltage supplied to the APD 201 to the voltage VH by passing a current corresponding to the voltage drop due to the quenching operation (recharge operation). The quenching element 202 may be, for example, a resistive element.

The waveform shaping unit 210 shapes the potential change of the cathode of the APD 201 obtained at the time of photon detection, and outputs a pulse signal. For example, an inverter circuit is used as the waveform shaping unit 210. Although FIG. 5 illustrates an example in which one inverter is used as the waveform shaping unit 210, the waveform shaping unit 210 may be a circuit in which a plurality of inverters are connected in series, or may be another circuit having a waveform shaping effect.

The counter circuit 211 counts the pulse signals output from the waveform shaping unit 210 and holds a digital signal indicating the count value. When a control signal is supplied from the vertical scanning circuit 110 through the driving line 213, the counter circuit 211 resets the held signal.

The selection circuit 212 is supplied with a control signal from the vertical scanning circuit 110 illustrated in FIG. 4 through the driving line 214 illustrated in FIG. 5. In response to this control signal, the selection circuit 212 switches between the electrical connection and the non-connection of the counter circuit 211 and the pixel output signal line 113. The selection circuit 212 includes, for example, a buffer circuit or the like for outputting a signal corresponding to a value held in the counter circuit 211.

In the example of FIG. 5, the selection circuit 212 switches between the electrical connection and the non-connection of the counter circuit 211 and the pixel output signal line 113; however, the method of controlling the signal output to the pixel output signal line 113 is not limited thereto. For example, a switch such as a transistor may be arranged at a node such as between the quenching element 202 and the APD 201 or between the photoelectric conversion unit 102 and the pixel signal processing unit 103, and the signal output to the pixel output signal line 113 may be controlled by switching the electrical connection and the non-connection. Alternatively, the signal output to the pixel output signal line 113 may be controlled by changing the value of the voltage VH or the voltage VL supplied to the photoelectric conversion unit 102 using a switch such as a transistor.

FIG. 5 illustrates a configuration example in which the counter circuit 211 is used. However, instead of the counter circuit 211, a time-to-digital converter (hereinafter referred to as TDC) and a memory may be used to acquire the timing of detecting the pulse. In this case, the generation timing of the pulse signal output from the waveform shaping unit 210 is converted into a digital signal by the TDC. In this case, a control signal (reference signal) may be supplied from the vertical scanning circuit 110 of FIG. 4 to the TDC via the driving line. The TDC acquires, as a digital signal, a signal indicating a relative time of an input timing of a pulse based on a control signal.

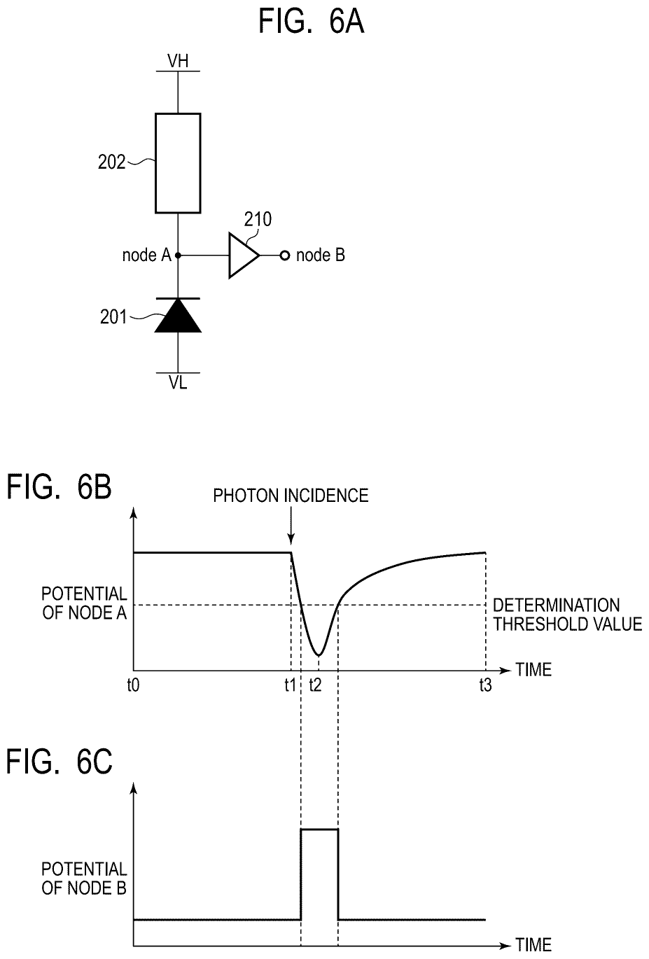

FIGS. 6A, 6B, and 6C are diagrams illustrating an operation of the APD 201 according to the embodiment. FIG. 6A is a diagram illustrating the APD 201, the quenching element 202, and the waveform shaping unit 210 in FIG. 5. As illustrated in FIG. 6A, the connection node of the APD 201, the quenching element 202, and the input terminal of the waveform shaping unit 210 is referred to as node A. Further, as illustrated in FIG. 6A, an output side of the waveform shaping unit 210 is referred to as node B.

FIG. 6B is a graph illustrating a temporal change in the potential of node A in FIG. 6A. FIG. 6C is a graph illustrating a temporal change in the potential of node B in FIG. 6A. During a period from time t0 to time t1, the voltage VH-VL is applied to the APD 201 in FIG. 6A. When a photon enters the APD 201 at the time t1, avalanche multiplication occurs in the APD 201. As a result, an avalanche current flows through the quenching element 202, and the potential of the node A drops. Thereafter, the amount of potential drop further increases, and the voltage applied to the APD 201 gradually decreases. Then, at time t2, the avalanche multiplication in the APD 201 stops. Thereby, the voltage level of node A does not drop below a certain constant value. Then, during a period from the time t2 to time t3, a current that compensates for the voltage drop flows from the node of the voltage VH to the node A, and the node A is settled to the original potential at the time t3.

In the above-described process, the potential of node B becomes the high level in a period in which the potential of node A is lower than a certain threshold value. In this way, the waveform of the drop of the potential of the node A caused by the incidence of the photon is shaped by the waveform shaping unit 210 and output as a pulse to the node B.

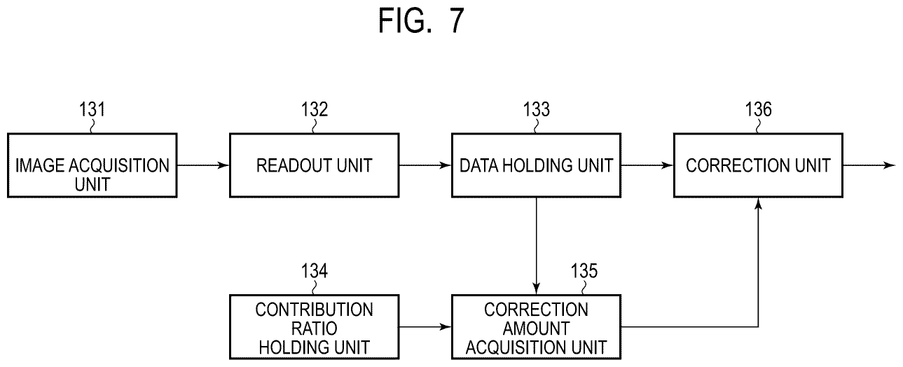

FIG. 7 is a functional block diagram related to correction processing of the information processing device according to the embodiment. The information processing device 1 includes an image acquisition unit 131, a readout unit 132, a data holding unit 133, a contribution ratio holding unit 134, a correction amount acquisition unit 135, and a correction unit 136.

The functions of the image acquisition unit 131 and the readout unit 132 are realized by, for example, the data input unit 121 in FIG. 1. More specifically, the functions of the image acquisition unit 131 and the readout unit 132 are realized by, for example, the photoelectric conversion unit 102, the pixel signal processing unit 103, the vertical scanning circuit 110, the horizontal scanning circuit 111, the reading circuit 112, the output circuit 114, and the like in FIGS. 3 to 5.

The functions of the data holding unit 133 and the contribution ratio holding unit 134 are realized by, for example, the data storage unit 122 or the information processing unit 129 in FIG. 1. The functions of the correction amount acquisition unit 135 and the correction unit 136 are realized by, for example, the information processing unit 129 in FIG. 1. The functions of the correction amount acquisition unit 135 and the correction unit 136 may be realized by the CPU 125 executing a correction processing program. The correction processing program may be stored in advance in the data storage unit 122 or the ROM 127, or may be acquired from another device via the communication unit 128. The operation of each of these units will be described later.

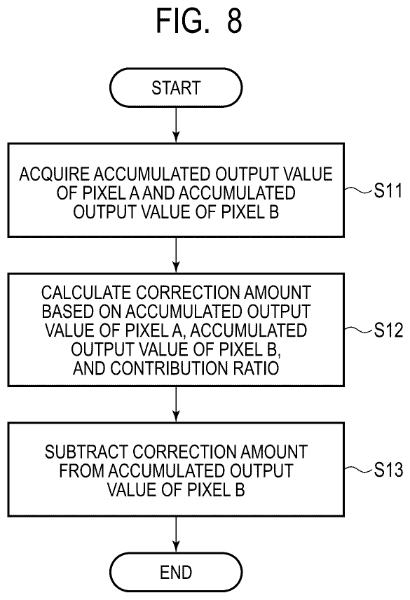

FIG. 8 is a flowchart illustrating correction processing executed by the information processing device according to the embodiment. The correction processing method of the embodiment will be described with reference to the flowchart of FIG. 8. In the description of FIG. 8, it is assumed that the image data acquired by the image acquisition unit 131 and the readout unit 132 is held in the data holding unit 133 in advance.

In step S11, the correction amount acquisition unit 135 acquires data including a pixel to be corrected (target pixel) and at least one pixel other than the target pixel from the image data held in the data holding unit 133. Hereinafter, one of the pixels other than the target pixel may be referred to as a pixel A (second pixel), and the target pixel may be referred to as a pixel B (first pixel). The data acquired at this time is an accumulated output value (second output value) obtained by accumulating a digital value (first output value) over N periods, the digital value indicating the presence or absence of avalanche multiplication in one period of a plurality of periods (first periods) into which one exposure period is divided. Here, N is an integer equal to or greater than two.

In step S12, the correction amount acquisition unit 135 calculates a correction amount based on the accumulated output value of the pixel A, the accumulated output value of the pixel B, and a contribution ratio. Here, the contribution ratio is a parameter indicating a probability that the output value of the pixel A is affected by the pixel B. In step S13, the correction unit 136 corrects the accumulated output value of the pixel B by subtracting the correction amount from the accumulated output value of the pixel B.

Here, a correction target in the embodiment will be described. In the embodiment, the correction of the noise component that the pixel A exerts on the pixel B is performed. Examples of such noise components include crosstalk caused by a light emission phenomenon when charges generated by avalanche multiplication are recombined in a case where the pixel includes an APD (hereinafter referred to as light emission crosstalk). For example, noise due to light emission crosstalk may be caused by a defective pixel, which outputs a signal with an abnormally high output value, and appear in pixels near the defective pixel, and in this case, cluster-like defects appear in the image. However, light emission crosstalk is an event that may occur in pixels other than defective pixels. Therefore, the correction targets for the noise caused by the pixel A may be output values of a specific part of the pixels or may be output values of all the pixels. In addition, the noise generation source considered in the calculation of the correction amount is not limited to one pixel A, and may be, for example, a pixel group including a plurality of pixels in the vicinity of the pixel B.

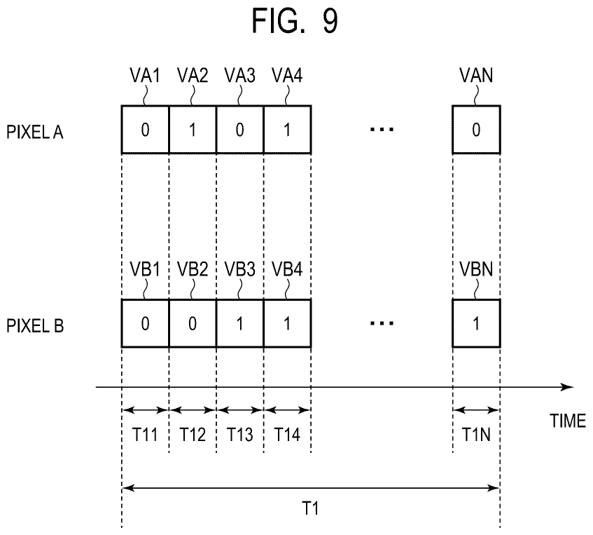

FIG. 9 is a diagram illustrating a concept of light emission crosstalk correction processing according to the embodiment. The correction of the embodiment will be described in more detail with reference to FIG. 9. In the following description, an example of processing for correcting a noise component due to light emission crosstalk that may occur in the case of FIG. 9 will be described. However, FIG. 9 and the description thereof are provided to assist understanding of the embodiment and do not limit the technical scope of the disclosure.

FIG. 9 schematically illustrates a plurality of determination operations within an exposure period T1, each determination operation including determining whether avalanche multiplication occurs in the pixel A and the pixel B. The exposure period T1 is divided into N periods T11 to T1N. In each of the periods T11 to T1N, it is determined whether avalanche multiplication occurs in each of the pixel A and the pixel B. In each period, “1” (second value) is output as an output value when avalanche multiplication occurs, and “O” (first value) is output as an output value when avalanche multiplication does not occur. The pixel A outputs N output values VA1 to VAN in the period T11 to the period T1N, respectively. The pixel B outputs N output values VB1 to VBN in the period T11 to the period T1N, respectively. In FIG. 9, values of “0” or “1” are indicated in boxes indicating the output values VA1 to VAN and VB1 to VBN. As described above, in the determination method of the embodiment, since the exposure period T1 is divided into the N periods T11 to T1N, the determination of the avalanche multiplication can be performed N times. Thus, the number of avalanche multiplications can be acquired in the range of zero to N. Note that the output values illustrated in FIG. 9 are values when there is no influence of light emission crosstalk.

Here, a conditional probability that light emission crosstalk occurs from the pixel A to the pixel B when avalanche multiplication occurs in the pixel A is defined as a contribution ratio K_{AB}. That is, the contribution ratio K_{AB} indicates the probability that the output value of the pixel B is affected when the output value of the pixel A is “1”. In this case, the presence or absence of the influence of the light emission crosstalk is classified into the following cases according to the presence or absence of the avalanche multiplication in the pixel A and the pixel B.

When avalanche multiplication occurs in neither the pixel A nor the pixel B as in the period T11 in FIG. 9, light emission crosstalk due to avalanche multiplication in the pixel A does not occur. In addition, even when avalanche multiplication does not occur in the pixel A and avalanche multiplication occurs in the pixel B as in the period T13 in FIG. 9, light emission crosstalk due to avalanche multiplication in the pixel A does not occur. Therefore, in these cases, the influence of light emission crosstalk does not occur.

When avalanche multiplication occurs in the pixel A and avalanche multiplication does not occur in the pixel B as in the period T12 in FIG. 9, light emission crosstalk due to avalanche multiplication in the pixel A occurs with a probability of the contribution ratio K_{AB}. In this situation, when the light emission crosstalk does not occur, the output value of the pixel B is “0”, and when the light emission crosstalk occurs, the output value of the pixel B is “1”. Therefore, in these cases, the output value of the pixel B may change due to the influence of the light emission crosstalk.

As in the period T14 of FIG. 9, even when avalanche multiplication occurs in both the pixel A and the pixel B, light emission crosstalk due to avalanche multiplication in the pixel A occurs with the probability of the contribution ratio K_{AB}. However, in this case, since the output value of the pixel B is originally “1”, the light emission crosstalk does not contribute to the output value of the pixel B. Therefore, in this case, the influence of the light emission crosstalk does not occur.

Therefore, among the four cases described above, the case where the influence of the light emission crosstalk occurs is the case where the avalanche multiplication occurs in the pixel A and the avalanche multiplication does not occur in the pixel B (the period T12 in FIG. 9). Therefore, by calculating the correction amount so as to correct the influence of the light emission crosstalk generated in the situation of this case, the influence of the light emission crosstalk on the output value of the pixel B can be appropriately corrected.

Here, it may be difficult to individually store “0” or “1”, which is an output value of each of the period T11 to the period T1N, in the data holding unit 133 for each period due to restrictions on resources of the memory or a transfer band of data. Therefore, in the embodiment, the data holding unit 133 is configured to store the accumulated value (accumulated output value) obtained by accumulating the output values over the period T11 to the period T1N without storing the output value of each of the period T11 to the period T1N. Specifically, the data holding unit 133 is configured to hold the accumulated output value of the pixel A in which the output values VA1 to VAN are accumulated and the accumulated output value of the pixel B in which the output values VB1 to VBN are accumulated. In this case, it is difficult to estimate the output value of each of the periods T11 to T1N from the accumulated output value. Therefore, in the embodiment, the correction amount is calculated by calculating the expected value of the number of cases in which avalanche multiplication occurs in the pixel A and avalanche multiplication does not occur in the pixel B using the probability of avalanche multiplication.

The probability that the output value of the pixel A is “1” is denoted as “p_{A1}”, and the probability that the output value of the pixel A is “0” is denoted as “p_{A0}”. Further, the probability that the output value of the pixel B is “1” is denoted as “p_{B1}”, and the probability that the output value of the pixel B is “0” is denoted as “p_{B0}”. In this case, since the accumulated output value of the pixel A is the number of periods in which the output value of the pixel A is “1” among the N periods, the probability p_{A1} is obtained by (accumulated output value of the pixel A)/N. In addition, the probability p_{A0} is (1−p_{A1}) because it is the probability of the complement of the event that the output value of the pixel A is “1”. Similarly, the probability p_{B1} is (accumulated output value of pixel B)/N, and the probability pro is (1−p_{B1}). Therefore, the “p_{A1}”, “p_{A0}”, “p_{B1}”, and “p_{B0}” can be calculated based on the accumulated output value of the pixel A, the accumulated output value of the pixel B, and the number of periods.

As described above, the influence of the light emission crosstalk occurs in the case where avalanche multiplication occurs in the pixel A and avalanche multiplication does not occur in the pixel B. Therefore, among these four probabilities, the probability p_{A1} (second probability) and the probability pro (first probability) are used to calculate the noise component due to the light emission crosstalk. By calculating an expected value from these probabilities, a noise component due to light emission crosstalk can be estimated. More specifically, the correction amount corresponding to the noise component affecting the accumulated output value of the pixel B among the light emission crosstalk generated from the pixel A to the pixel B is obtained by the following Expression (1).

$${p}_{A 1} \times {p}_{B 0} \times {K}_{AB} \times N \qquad ( 1 )$$

By subtracting the correction amount obtained by Expression (1) from the accumulated output value of the pixel B, the influence of the light emission crosstalk can be corrected.

Note that the output values VA1 to VAN and the output values VB1 to VBN may be individually acquired from the pixel A and the pixel B. In such a case, the number of cases where avalanche multiplication occurs in the pixel A and avalanche multiplication does not occur in the pixel B can be directly counted without calculating the expected value using probabilities. In this case, the correction amount may be calculated based on the number of cases described above and the contribution ratio K_{AB}.

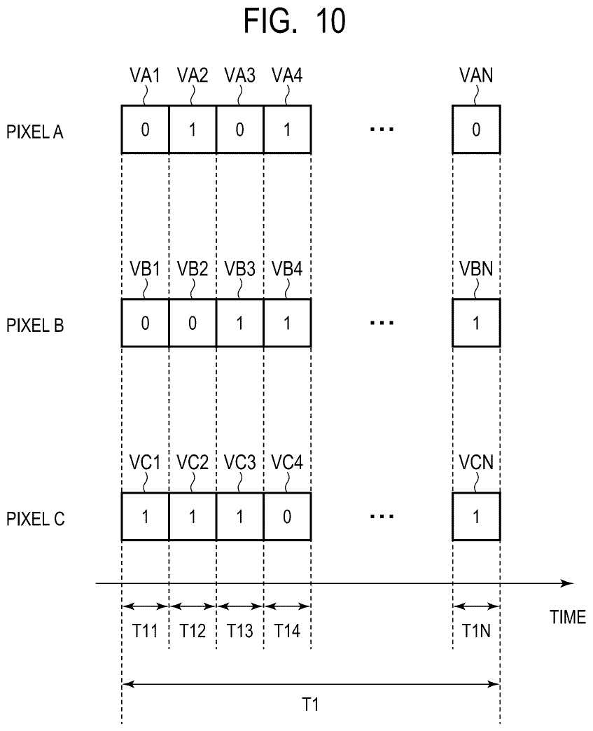

A modified example in which the light emission crosstalk correction processing described with reference to FIG. 9 is expanded when there are a plurality of pixels causing light emission crosstalk will be described. FIG. 10 is a diagram illustrating a concept of light emission crosstalk correction processing according to the embodiment. FIG. 10 illustrates an example in which there are two pixels that cause light emission crosstalk with respect to the pixel B in the example of FIG. 9. Like FIG. 9, FIG. 10 and its description are provided to assist in understanding the embodiment and do not limit the scope of the disclosure.

In the example of FIG. 10, it is assumed that light emission crosstalk occurs from the pixel A and a pixel C to the pixel B. The pixel A and the pixel B are similar to those in FIG. 9. N output values VC1 to VCN are output from the pixel C in the period T11 to the period T1N, respectively. A conditional probability that light emission crosstalk occurs from the pixel C to the pixel B when avalanche multiplication occurs in the pixel C is defined as a contribution ratio K_{CB}. As in the description using FIG. 9, the case where the influence of the light emission crosstalk occurs is a case where avalanche multiplication occurs in the pixel C and avalanche multiplication does not occur in the pixel B. The probability that the output value of the pixel C is “1” is denoted as “p_{C1}”. The correction amount corresponding to the noise component affecting the accumulated output value of the pixel B among the light emission crosstalk generated from the pixel A and the pixel C to the pixel B is obtained by the following Expression (2) according to the inclusion-exclusion principle.

$${p}_{B 0} \times ( {p}_{A 1} \times {K}_{AB} + {p}_{C 1} \times {K}_{CB} - {p}_{A 1} \times {K}_{AB} \times {p}_{C 1} \times {K}_{CB} ) \times N \qquad ( 2 )$$

In addition, in a case where the number of pixels in which the light emission crosstalk occurs with respect to the pixel B is three or more, it is also possible to derive the calculation expression of the correction amount by using the inclusion-exclusion principle in the same manner. Therefore, the embodiment can be applied regardless of the number of pixels in which light emission crosstalk occurs.

When the contribution ratio K_{AB} and the contribution ratio K_{CB} are sufficiently small, the calculation expression of the correction amount may be approximated so as to ignore the term in which the contribution ratios are multiplied a plurality of times. For example, the following Expression (3), which is an approximate equation obtained by ignoring a term including (K_{AB}×K_{CB}) of the Expression (2), may be used as the calculation expression of the correction amount.

$$( {p}_{A 1} \times {p}_{B 0} \times {K}_{AB} + {p}_{C 1} \times {p}_{B 0} \times {K}_{CB} ) \times N \qquad ( 3 )$$

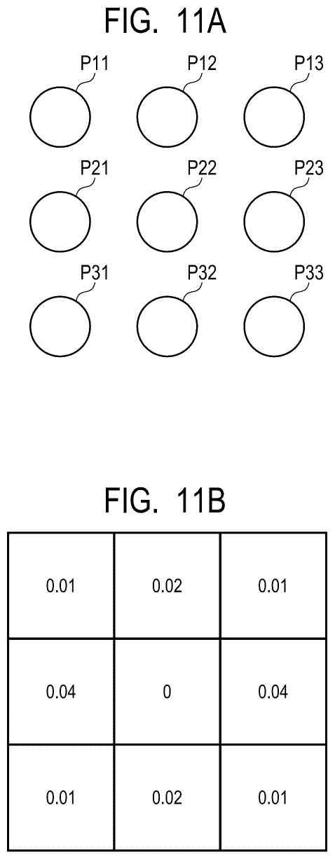

FIGS. 11A and 11B are diagrams illustrating contribution ratios of the light emission crosstalk correction processing according to the embodiment. With reference to FIGS. 11A and 11B, an example of the contribution ratio reference method according to the embodiment will be described.

FIG. 11A is a diagram schematically illustrating a part of the pixel array. A target pixel P22 arranged at the center of FIG. 11A is the correction target. In the correction of the target pixel P22, a range of three rows and three columns including the target pixel P22 is referred to. That is, the target pixel P22 and the pixels P11, P12, P13, P21, P23, P31, P32, and P33 near the target pixel P22 are referred to.

FIG. 11B is a table illustrating contribution ratios in a matrix form. The second row and the second column in FIG. 11B correspond to the position of the target pixel P22. Here, the contribution ratio from a certain pixel to the target pixel is determined according to the relative position of the pixel with respect to the target pixel in the pixel array. The values of the contribution ratios in FIG. 11B are held in advance in the contribution ratio holding unit 134 in the form of array data or the like. The values of the contribution ratios can be obtained statistically in advance by, for example, examining the correlation between the position of a pixel and the occurrence probability of light emission crosstalk from actual measurement data or the like.

That is, nine numerical values arranged in three rows and three columns of the table of FIG. 11B indicate contribution ratios of pixels at corresponding positions of FIG. 11A. For example, the contribution ratio of the pixel P12 arranged in the first row and the second column to the target pixel P22 is 0.02. It is assumed that the contribution ratios from the pixels located outside the three rows and the three columns of the table of FIG. 11B are zero. For example, if the pixel P33 is the target pixel, the contribution ratios from the pixels P11, P12, P13, P21, and P31 are zero.

The method of setting the contribution ratios illustrated in FIGS. 11A and 11B is merely an example, and is not limited thereto. For example, the range in which the contribution ratios are set centering on the target pixel is not limited to three rows and three columns. The values of the contribution ratios are not limited to that illustrated in FIG. 11B. The position of the target pixel is not limited to the center of the matrix of contribution ratios.

As described above, in the information processing device 1 according to the embodiment, correction can be performed in consideration of the probability that a certain pixel becomes a noise source with respect to another pixel based on the accumulated output values of a plurality of pixels. Therefore, according to the embodiment, an information processing device and an information processing method capable of more suitably correcting an output signal are provided. As described above, when the photoelectric conversion element included in the pixel is the APD, the correction method of the embodiment is more suitable for correction of light emission crosstalk that may occur between APDs.

### Second Embodiment

In the embodiment, a modification of the correction processing of the first embodiment will be described. In the embodiment, description of elements common to those of the first embodiment may be omitted or simplified.

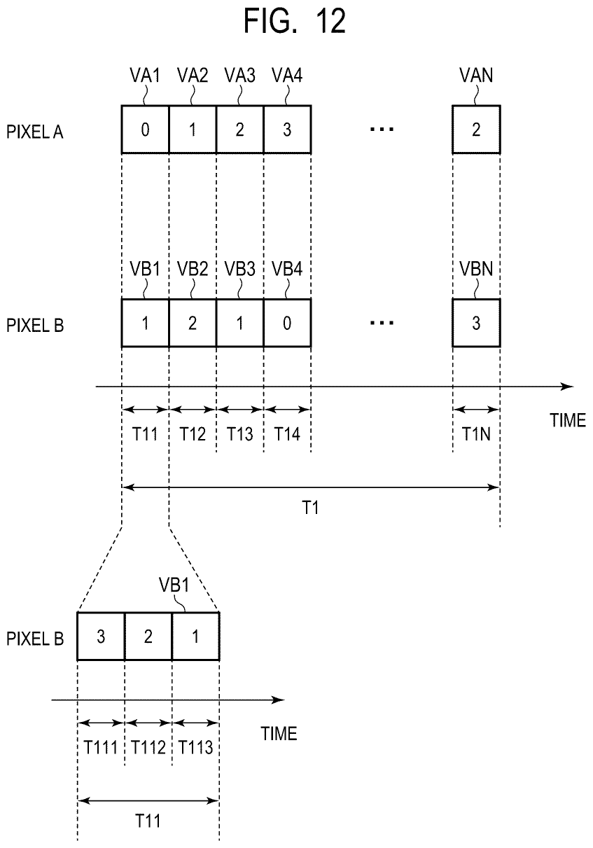

FIG. 12 is a diagram illustrating the concept of the light emission crosstalk correction processing according to the embodiment. The correction of the embodiment will be described in more detail with reference to FIG. 12. Hereinafter, an example of processing for correcting a noise component due to light emission crosstalk that may occur in the case of FIG. 12 will be described. However, FIG. 12 and the description thereof are provided to assist in understanding the embodiment and do not limit the technical scope of the disclosure.

FIG. 12 schematically illustrates a plurality of determination operations within an exposure period T1, each determination operation including determining whether avalanche multiplication occurs in the pixel A and the pixel B. The exposure period T1 is divided into N periods T11 to T1N. In each of the periods T11 to T1N, it is determined whether avalanche multiplication occurs in each of the pixel A and the pixel B. When avalanche multiplication occurs in each period, “1”, “2”, or “3” is output as an output value in accordance with the timing at which avalanche multiplication occurs, and “0” is output as an output value when avalanche multiplication does not occur. That is, in the embodiment, when avalanche multiplication occurs, a variable value that is an integer equal to or greater than one is output in accordance with the timing at which avalanche multiplication occurs. In FIG. 12, in the boxes indicating the output values VA1 to VAN and VB1 to VBN, values of “0”, “1”, “2”, or “3” are indicated. Note that the output values illustrated in FIG. 12 are values when there is no influence of light emission crosstalk.

In the embodiment, each of the N periods T11 to T1N is further divided into three sub-periods (second periods). FIG. 12 illustrates, as an example, three sub-periods T111, T112, and T113 included in the period T11. The sub-period T111 is the first sub-period in the period T11, and the sub-period T112 is a sub-period next to the sub-period T111. The sub-period T113 is a sub-period next to the sub-period T112 and is the last sub-period in the period T11. Each of the periods T12 to T1N also includes three sub-periods.

When avalanche multiplication occurs in the sub-period T111, “3” is output as the output value of the period T11. When avalanche multiplication occurs in the sub-period T112, “2” is output as the output value of the period T11. When avalanche multiplication occurs in the sub-period T113, “1” is output as the output value of the period T11. As described above, in the embodiment, the adjustment of the output value is performed such that a larger output value is output as the timing at which the avalanche multiplication occurs in one period is earlier. When avalanche multiplication does not occur in any of the sub-period T111 to the sub-period T113, “0” is output as the output value of the period T11. FIG. 12 illustrates an example in which avalanche multiplication occurs in the sub-period T113. Therefore, the output value VB1 in the period T11 is “1”.

When avalanche multiplication occurs in two or more of the sub-periods T111, T112, and T113, an output value corresponding to the earliest sub-period among two or more sub-periods in which avalanche multiplication occurs is output. For example, when avalanche multiplication occurs in both the sub-period T112 and the sub-period T113, “2” is output as the output value.

In the embodiment, when avalanche multiplication occurs in a certain pixel in a certain sub-period, noise due to light emission crosstalk may occur with respect to an output value in another pixel in the same sub-period. That is, in a case where avalanche multiplication occurs in the pixel A and avalanche multiplication does not occur in the pixel B in one period, light emission crosstalk due to avalanche multiplication occurring in the pixel A may affect the output value of the pixel B. In addition, in one period, even in a case where the sub-period in which avalanche multiplication occurs in the pixel A is earlier than the sub-period in which avalanche multiplication occurs in the pixel B, the influence of light emission crosstalk may occur.

The probabilities that the output values of the pixel A are “0”, “1”, “2”, and “3” are denoted as “p_{A0}”, “p_{A1}”, “p_{A2}”, and “p_{A3}”, respectively. The probabilities that the output values of the pixel B are “0”, “1”, “2”, and “3” are denoted as “p_{B0}”, “p_{B1}”, “p_{B2}”, and “p_{B3}”, respectively. As described in the first embodiment, these probabilities are used to calculate noise components due to light emission crosstalk. Therefore, first, a method of calculating the “p_{A0}”, “p_{A1}”, “p_{A2}”, “p_{A3}”, “p_{B0}”, “p_{B1}”, “p_{B2}”, and “p_{B3}” will be described.

It is assumed that the lengths of the three sub-periods are the same. At this time, the expected value Cₑₓₚ of the accumulated output value in the case where P photons are incident on a certain pixel within N periods is obtained by the following Expressions (4) to (8).

$$d [ 0 ] = 0 \qquad ( 4 )$$

$$d [ 1 ] = 1 - {e}^{- \frac{P \times 1}{N \times 3}} \qquad ( 5 )$$

$$d [ 2 ] = 1 - {e}^{- \frac{P \times 2}{N \times 3}} \qquad ( 6 )$$

$$d [ 3 ] = 1 - {e}^{- \frac{P \times 3}{N \times 3}} \qquad ( 7 )$$

$${C}_{exp} = \{ 3 \times ( d [ 1 ] - d [ 0 ] ) + 2 \times ( d [ 2 ] - d [ 1 ] ) + 1 \times ( d [ 3 ] - d [ 2 ] ) \} \times N \qquad ( 8 )$$

Note that, the “e” in these expressions is the Napier's constant (the base of the natural logarithm). Further, the “d[1]” in these expressions is a probability that avalanche multiplication occurs in the first sub-period (T111 in FIG. 12). The “d[2]” is the probability that avalanche multiplication occurring occurs in the first sub-period or the second sub-period (T112 in FIG. 12). The “d[3]” is a probability that avalanche multiplication occurs in any of the first sub-period, the second sub-period, and the last sub-period (T113 in FIG. 12). The “d[0]” is a dummy parameter appearing in the derivation of Expression (8), and is always zero.

The accumulated output value and the number of incident photons are associated with each other by Expressions (4) to (8). From the accumulated output value C_{A} of the pixel A in the N periods, an expected value P_{A} of the number of photons incident on the pixel A can be obtained by an inverse conversion table based on Expressions (4) to (8). Then, based on the expected value P_{A}, the “p_{A0}”, “p_{A1}”, “p_{A2}”, and “p_{A3}” (second probability group) can be calculated by the following Expressions (9) to (12).

$${p}_{A 1} = 1 - {e}^{- \frac{{P}_{A} \times 1}{N \times 3}} \qquad ( 9 )$$

$${p}_{A 2} = 1 - {e}^{- \frac{{P}_{A} \times 2}{N \times 3}} - {p}_{A 1} \qquad ( 10 )$$

$${p}_{A 3} = 1 - {e}^{- \frac{{P}_{A} \times 3}{N \times 3}} - {p}_{A 1} - {p}_{A 2} \qquad ( 11 )$$

$${p}_{A 0} = 1 - {p}_{A 1} - {p}_{A 2} - {p}_{A 3} \qquad ( 12 )$$

The “p_{B0}”, “p_{B1}”, “p_{B2}”, and “p_{B3}” (first probability group) can be similarly calculated. Therefore, given the accumulated output value C_{A} of the pixel A and the accumulated output value C_{B} of the pixel B, the “p_{A0}”, “p_{A1}”, “p_{A2}”, “p_{A3}”, “p_{B0}”, “p_{B1}”, “p_{B2}”, and “p_{B3}” can be calculated. In this case, the correction amount corresponding to the noise component affecting the accumulated output value C_{B} of the pixel B among the light emission crosstalk generated from the pixel A to the pixel B is obtained by the following Expression (13).

$$\{ {\sum }_{x = 0}^{2} {\sum }_{y = x + 1}^{3} ( {p}_{Ay} \times {p}_{Bx} \times ( y - x ) ) \} \times {K}_{AB} \times N \qquad ( 13 )$$

Expression (13) is a sum of noise components in a plurality of cases where the influence of light emission crosstalk occurs among possible combinations of output values of the pixel A and the pixel B. As described above, in the embodiment, when avalanche multiplication occurs in two or more sub-periods, it is assumed that an output value corresponding to the earliest sub-period is output. Therefore, in Expression (13), the index of the sigma symbol is set so as not to include the case where the avalanche multiplication timing of the pixel A is later than the avalanche multiplication timing of the pixel B. However, when another premise is adopted, the Expression (13) may be appropriately modified. In addition, in a case where there are a plurality of pixels that cause light emission crosstalk with respect to the pixel B, the calculation expression of the correction amount can be expanded by the same concept as in the first embodiment.

In the embodiment, the number of sub-periods is three as an example, but the number of sub-periods is not limited thereto. The number of sub-periods may be any integer equal to or greater than two, and in that case, Expressions (4) to (13) may be modified as appropriate. In the embodiment, the lengths of the plurality of sub-periods are the same, but it is not limited thereto. The lengths of the plurality of sub-periods may be different from each other, and in this case, Expressions (4) to (13) may be appropriately modified. In the modification of Expressions (4) to (13), the probability of avalanche multiplication occurring in a sub-period can be calculated by the following Expression (14) using the number N of periods, the number P of incident photons, the length L of one period, and the length l (l≤L) of the sub-period from the start time of one period to a certain time.

$$1 - {e}^{- \frac{P \times l}{N \times L}} \qquad ( 14 )$$

The probability calculation method of Expression (14) is applicable to all sub-period setting methods, and thus is also applicable to the case where the lengths of a plurality of sub-periods are different from each other. For example, the first sub-period may be from a start time of one period to a time of one eighth, the second sub-period may be from a time of one eighth of one period to a time of four eighths, and the last sub-period may be from a time of four eighths of one period to an end time of one period.

As another modification, “2” may be output as an output value when avalanche multiplication occurs in an odd-numbered sub-period among a plurality of sub-periods, and “1” may be output as an output value when avalanche multiplication occurs in an even-numbered sub-period. In this way, the same output value may be associated with two of the plurality of sub-periods.

As described above, in the embodiment, one period is divided into a plurality of sub-periods, and different output values can be generated according to the sub-periods in which avalanche multiplication occurs. By using the calculation expression of the correction amount according to the embodiment, the noise component can be corrected in the same manner as in the first embodiment even in such a configuration. Therefore, according to the embodiment, an information processing device and an information processing method capable of more suitably correcting an output signal are provided.

### Third Embodiment

In the embodiment, a modification of the correction processing of the second embodiment will be described. In the embodiment, description of elements common to those of the second embodiment may be omitted or simplified.

In the calculation of Expression (13) in the second embodiment, the number of terms to be calculated may be enormous depending on conditions such as the number of sub-periods. In this case, the calculation time of the correction amount acquisition unit 135 may be a bottleneck of processing in the information processing device 1. Therefore, in the embodiment, a method of reducing the calculation time by simplifying the calculation of Expression (13) will be described.

The method of reducing the calculation time will be described using the second embodiment as an example. In the second embodiment, the calculation may be performed in the following flow. First, the accumulated output value C_{A} of the pixel A and the accumulated output value C_{B} of the pixel B are given. Using the accumulated output values C_{A} and C_{B} as inputs, the expected value P_{A} of the number of photons incident on the pixel A and the expected value P_{B} of the number of photons incident on the pixel B can be obtained by an inverse conversion table based on Expressions (4) to (8). Then, using the expected values P_{A} and P_{B} as inputs, the “p_{A0}”, “p_{A1}”, “p_{A2}”, “p_{A3}”, “p_{B0}”, “p_{B1}”, “p_{B2}”, and “p_{B3}” of Expressions (9) to (12) can be calculated. Then, by inputting these probabilities to Expression (13), the correction amount can be calculated. According to the above-described calculation flow, when the accumulated output values C_{A} and C_{B} are input, the correction amount is uniquely determined.

Therefore, the calculation time can be shortened by calculating the correction amount in advance for all possible combinations of the accumulated output value C_{A} of the pixel A and the accumulated output value C_{B} of the pixel B and holding them in the correction amount acquisition unit 135 or the like. The correction amount calculated in advance can be held, for example, in the form of a lookup table in which the correction amount L is associated with the accumulated output value C_{A} of the pixel A and the accumulated output value C_{B} of the pixel B.

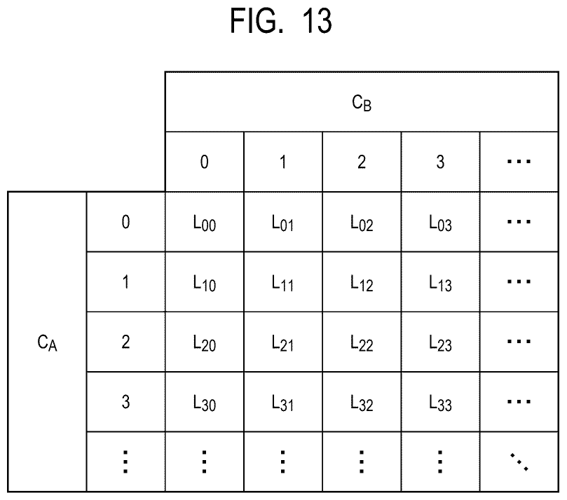

FIG. 13 is a diagram illustrating an example of a lookup table according to the embodiment. As illustrated in FIG. 13, the accumulated output value C_{A} of the pixel A and the accumulated output value C_{B} of the pixel B are integers equal to or greater than zero. By configuring the lookup table so that one correction amount Lᵢⱼ is associated with each of these possible combinations of values, the arithmetic processing of Expressions (4) to (13) can be replaced with reference processing of the lookup table. This may reduce computation time.

Note that it is not essential that the correction amount Lᵢⱼ is held in the lookup table so as to correspond to all possible combinations of the accumulated output value C_{A} of the pixel A and the accumulated output value C_{B} of the pixel B. In the lookup table, a correction amount Lᵢⱼ corresponding to a part of possible values of the accumulated output value C_{A} of the pixel A and the accumulated output value C_{B} of the pixel B may be held. In this case, when the accumulated output value C_{A} of the pixel A and the accumulated output value C_{B} of the pixel B are input in a combination not included in the lookup table, the correction amount Lᵢⱼ may be calculated by interpolation processing. Thus, the size of the lookup table to be held can be reduced.

Therefore, according to the embodiment, as in the first embodiment and the second embodiment, an information processing device and an information processing method capable of more suitably correcting an output signal are provided. Further, according to the embodiment, the calculation time can be shortened.

### Fourth Embodiment

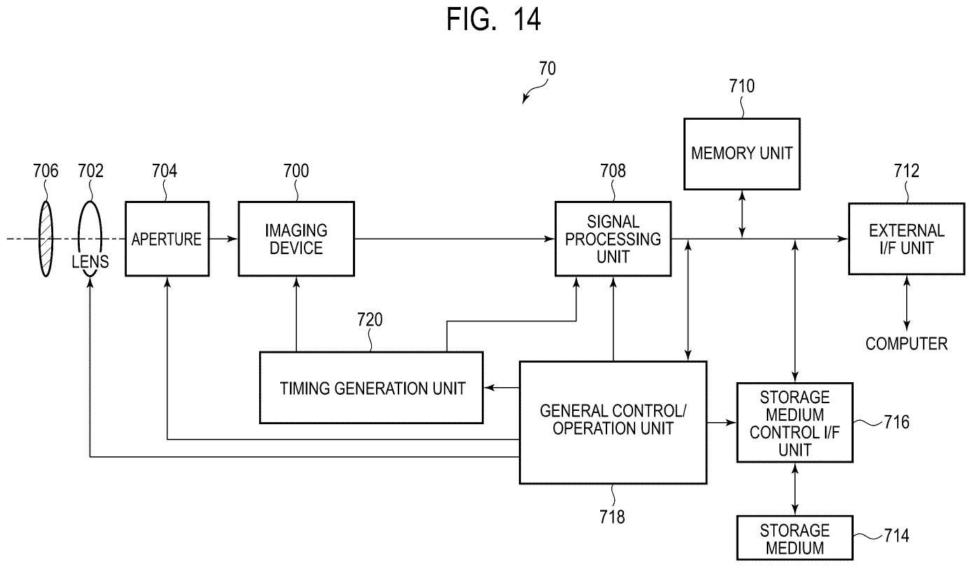

The information processing device 1 of the above embodiments can be applied to various equipment. Examples of the equipment include a digital still camera, a digital camcorder, a camera head, a copying machine, a facsimile, a mobile phone, a vehicle-mounted camera, an observation satellite, and a surveillance camera. FIG. 14 is a block diagram of a digital still camera as an example of equipment. FIG. 14 illustrates an example in which the information processing device 1 illustrated in FIG. 1 is applied to a digital still camera.

The equipment 70 illustrated in FIG. 14 includes a barrier 706, a lens 702, an aperture 704, and an imaging device 700 (an example of the photoelectric conversion device). The equipment 70 further includes a signal processing unit (processing device) 708, a timing generation unit 720, a general control/operation unit 718 (control device), a memory unit 710 (storage device), a storage medium control I/F unit 716, a storage medium 714, and an external I/F unit 712. At least one of the barrier 706, the lens 702, and the aperture 704 is an optical device corresponding to the equipment. The barrier 706 protects the lens 702, and the lens 702 forms an optical image of an object on the imaging device 700. The aperture 704 varies the amount of light passing through the lens 702. The imaging device 700 is configured as in the above embodiments, and converts an optical image formed by the lens 702 into image data (image signal). The signal processing unit 708 performs various corrections, data compression, and the like on the image data output from the imaging device 700. The timing generation unit 720 outputs various timing signals to the imaging device 700 and the signal processing unit 708. The general control/operation unit 718 controls the entire digital still camera, and the memory unit 710 temporarily stores image data. The storage medium control I/F unit 716 is an interface for storing or reading image data on the storage medium 714, and the storage medium 714 is a detachable storage medium such as a semiconductor memory for storing or reading image data. The external I/F unit 712 is an interface for communicating with an external computer or the like. The timing signal or the like may be input from the outside of the equipment. The equipment 70 may further include a display device (a monitor, an electronic view finder, or the like) for displaying information obtained by the photoelectric conversion device. The equipment includes at least a photoelectric conversion device. Further, the equipment 70 includes at least one of an optical device, a control device, a processing device, a display device, a storage device, and a mechanical device that operates based on information obtained by the photoelectric conversion device. The mechanical device is a movable portion (for example, a robot arm) that receives a signal from the photoelectric conversion device for operation.

Each pixel may include a plurality of photoelectric conversion units (a first photoelectric conversion unit and a second photoelectric conversion unit). The signal processing unit 708 may be configured to process a pixel signal based on charges generated in the first photoelectric conversion unit and a pixel signal based on charges generated in the second photoelectric conversion unit, and acquire distance information from the imaging device 700 to an object.

### Fifth Embodiment

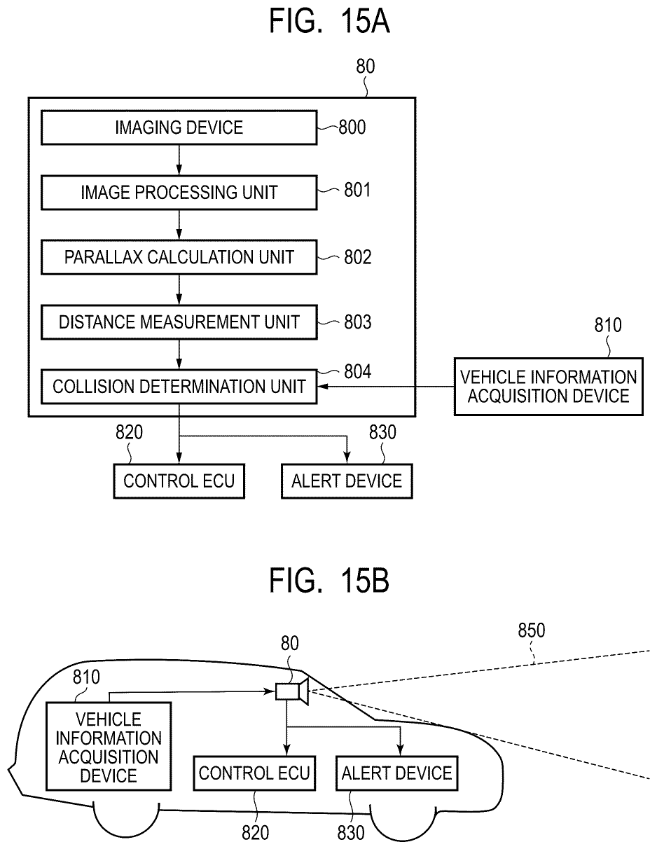

FIGS. 15A and 15B are block diagrams of equipment relating to the vehicle-mounted camera according to the embodiment. FIGS. 15A and 15B illustrate an example in which the information processing device 1 illustrated in FIG. 1 is applied to a movable body such as a vehicle. The equipment 80 includes an imaging device 800 (an example of the photoelectric conversion device) and a signal processing device (processing device) that processes a signal from the imaging device 800. The equipment 80 includes an image processing unit 801 that performs image processing on a plurality of pieces of image data acquired by the imaging device 800, and a parallax calculation unit 802 that calculates parallax (phase difference of parallax images) from the plurality of pieces of image data acquired by the equipment 80. The equipment 80 includes a distance measurement unit 803 that calculates a distance to an object based on the calculated parallax, and a collision determination unit 804 that determines whether or not there is a possibility of collision based on the calculated distance. Here, the parallax calculation unit 802 and the distance measurement unit 803 are examples of a distance information acquisition unit that acquires distance information to the object. That is, the distance information is information on a parallax, a defocus amount, a distance to the object, and the like. The collision determination unit 804 may determine the possibility of collision using any of these pieces of distance information. The distance information acquisition unit may be realized by dedicatedly designed hardware or software modules. Further, it may be realized by a field programmable gate array (FPGA), an application specific integrated circuit (ASIC) or a combination thereof.

The equipment 80 is connected to the vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm such as a sound, displaying alert information on a screen of a car navigation system or the like, or giving vibration to a seat belt or a steering wheel. The equipment 80 functions as a control unit that controls the operation of controlling the vehicle as described above.

In the embodiment, an image of the periphery of the vehicle, for example, the front or the rear is captured by the equipment 80. FIG. 15B illustrates equipment in a case where an image is captured in front of the vehicle (image capturing range 850). The vehicle information acquisition device 810 as the imaging control unit sends an instruction to the equipment 80 or the imaging device 800 to perform the imaging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### OTHER EMBODIMENTS

The disclosure is not limited to the above embodiments, and various modifications are possible. For example, an example in which some of the configurations of any one of the embodiments are added to other embodiments or an example in which some of the configurations of any one of the embodiments are replaced with some of the configurations of other embodiments are also embodiments of the disclosure.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A+B) is omitted. This is because it is assumed that “A is not B” is considered when “A is B” is described.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that the above-described embodiments are merely specific examples for carrying out the disclosure, and the technical scope of the disclosure should not be interpreted in a limited manner by these embodiments. That is, the disclosure can be implemented in various forms without departing from the technical idea or the main features thereof.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-196104, filed Nov. 8, 2024, which is hereby incorporated by reference herein in its entirety.

What is claimed is:

1. A device comprising:
an acquisition unit configured to acquire a correction amount of a signal generated by photoelectrically converting incident light in each of a plurality of pixels; and
a correction unit configured to correct the signal based on the correction amount,
wherein one exposure period in each of the plurality of pixels is divided into a plurality of first periods,
wherein a first output value of each of the plurality of pixels is generated in each of the plurality of first periods,
wherein the signal including a second output value that is an accumulated value of the first output values over the plurality of first periods is input to the acquisition unit for each pixel,
wherein the acquisition unit calculates, based on the second output value of a first pixel among the plurality of pixels, a first probability that one of possible values of the first output value is generated in each of the plurality of first periods,
wherein the acquisition unit calculates, based on the second output value of a second pixel among the plurality of pixels, a second probability that one of possible values of the first output value is generated in each of the plurality of first periods, and
wherein the acquisition unit calculates the correction amount based on the first probability and the second probability.

2. The device according to claim 1,
wherein the first probability is a probability that a first value is generated, and
wherein the second probability is a probability that a second value different from the first value is generated.

3. The device according to claim 2,
wherein the first value is zero, and
wherein the second value is an integer equal to or greater than one.

4. The device according to claim 1, wherein the acquisition unit calculates the correction amount based on a product of the first probability and the second probability.

5. The device according to claim 1, wherein the acquisition unit calculates the correction amount based on a product of the first probability, the second probability, and the number of the plurality of first periods in the one exposure period.

6. The device according to claim 1, wherein the acquisition unit calculates the correction amount further based on a contribution ratio including a probability that the first output value of the first pixel is affected by the second pixel when the first output value of the second pixel is a predetermined value.

7. The device according to claim 6, wherein the acquisition unit calculates the correction amount based on a product of the first probability, the second probability, the number of the plurality of first periods in the one exposure period, and the contribution ratio.

8. The device according to claim 6, wherein the contribution ratio includes a value corresponding to a relative position of the second pixel with respect to the first pixel in an array of the plurality of pixels.

9. The device according to claim 1,
wherein the first output value is based on incidence of a photon on an avalanche photodiode,
wherein the first probability is a probability that avalanche multiplication based on incidence of a photon on the avalanche photodiode does not occur in one first period, and
wherein the second probability is a probability that avalanche multiplication based on incidence of a photon on the avalanche photodiode occurs in one first period.

10. The device according to claim 1,
wherein the first output value is based on incidence of a photon on an avalanche photodiode, and
wherein the correction amount indicates an amount of crosstalk caused by light generated by recombination of charges generated by avalanche multiplication in the avalanche photodiode.

11. The device according to claim 1,
wherein each of the plurality of first periods is further divided into a plurality of second periods,
wherein when incidence of a photon is not detected in any of the plurality of second periods, the first output value is a first value,
wherein when incidence of a photon is detected in any of the plurality of second periods, the first output value is a variable value corresponding to a second period in which incidence of a photon is detected among the plurality of second periods.

12. The device according to claim 11, wherein when incidence of a photon is detected in two or more of the plurality of second periods, the first output value is a value corresponding to the earliest second period among second periods in which incidence of a photon is detected.

13. The device according to claim 11, wherein lengths of two of the plurality of second periods are different from each other.

14. The device according to claim 11, wherein the first output value when incidence of a photon is detected in any of the plurality of second periods is a larger value as a second period in which incidence of a photon is detected is earlier.

15. The device according to claim 1,
wherein the acquisition unit generates a first probability group by calculating, based on the second output value of the first pixel, for each possible value of the first output value, a probability that one of possible values of the first output value is generated in each of the plurality of first periods, and
wherein the acquisition unit generates a second probability group by calculating, based on the second output value of the second pixel, for each possible value of the first output value, a probability that one of possible values of the first output value is generated in each of the plurality of first periods, and
wherein the acquisition unit calculates the correction amount based on the first probability group and the second probability group.

16. The device according to claim 1, wherein the correction unit corrects the signal by subtracting the correction amount from the second output value of the first pixel.

17. A conversion device comprising:
the plurality of pixels; and
the device according to claim 1, signals output from the plurality of pixels being input to the device.

18. A device comprising:
an acquisition unit configured to acquire a correction amount of a signal generated by photoelectrically converting incident light in each of a plurality of pixels; and
a correction unit configured to correct the signal based on the correction amount,
wherein one exposure period in each of the plurality of pixels is divided into a plurality of first periods,
wherein a first output value of each of the plurality of pixels is generated in each of the plurality of first periods,
wherein the signal including a second output value that is an accumulated value of the first output values over the plurality of first periods is input to the acquisition unit for each pixel,
wherein the acquisition unit acquires, based on the second output value of a first pixel among the plurality of pixels and the second output value of a second pixel among the plurality of pixels, the correction amount by referring to a table, and
wherein the table includes a correction amount calculated in advance based on a first probability that one of possible values of the first output value is generated in the first pixel in each of the plurality of first periods and a second probability that one of possible values of the first output value is generated in the second pixel in each of the plurality of first periods.

19. A method comprising:
acquiring a correction amount of a signal generated by photoelectrically converting incident light in each of a plurality of pixels; and
correcting the signal based on the correction amount,
wherein one exposure period in each of the plurality of pixels is divided into a plurality of first periods,
wherein a first output value of each of the plurality of pixels is generated in each of the plurality of first periods,
wherein the signal including a second output value that is an accumulated value of the first output values over the plurality of first periods is input for each pixel,
wherein in the acquiring of the correction amount,
a first probability that one of possible values of the first output value is generated in each of the plurality of first periods is calculated based on the second output value of a first pixel among the plurality of pixels,
a second probability that one of possible values of the first output value is generated in each of the plurality of first periods is calculated based on the second output value of a second pixel among the plurality of pixels, and
the correction amount is calculated based on the first probability and the second probability.

20. A method comprising:
acquiring a correction amount of a signal generated by photoelectrically converting incident light in each of a plurality of pixels; and
correcting the signal based on the correction amount,
wherein one exposure period in each of the plurality of pixels is divided into a plurality of first periods,
wherein a first output value of each of the plurality of pixels is generated in each of the plurality of first periods,
wherein the signal including a second output value that is an accumulated value of the first output values over the plurality of first periods is input for each pixel,
wherein in the acquiring of the correction amount, the correction amount is acquired by referring to a table based on the second output value of a first pixel among the plurality of pixels and the second output value of a second pixel among the plurality of pixels, and
wherein the table includes a correction amount calculated in advance based on a first probability that one of possible values of the first output value is generated in the first pixel in each of the plurality of first periods and a second probability that one of possible values of the first output value is generated in the second pixel in each of the plurality of first periods.
